(19) United States
(12) Patent Application Publication
(10) Pub. No.: US 2017/0372124 A1
(43) Pub. Date: Dec. 28, 2017

(54) UNOBTRUSIVE IDENTITY MATCHER: A TOOL FOR REAL-TIME VERIFICATION OF IDENTITY

(71) Applicant: Sciometrics LLC, Chantilly, VA (US)

(72) Inventors: Mark A. WALCH, Herndon, VA (US); Jerald SUSSMAN, Herndon, VA (US); Frank J. FITZSIMMONS, Washington, DC (US); Richard SMITH, Chantilly, VA (US)

(73) Assignee: Sciometrics LLC, Chantilly, VA (US)

(21) Appl. No.: 15/539,630

(22) PCT Filed: Dec. 24, 2015
(86) PCT No.: PCT/US2015/000444

§ 371 Date: Jun. 23, 2017

Related U.S. Application Data
(60) Provisional application No. 62/096,767, filed on Dec. 24, 2014.

(51) Int. Cl. G06K 9/00; G06F 21/32; G06K 9/64

(52) U.S. Cl. CPC G06K 9/00093; G06K 9/64; G06F 21/32; G06K 9/0008; G06K 9/001

(57) ABSTRACT

A mobile device comprising memory configured to store instructions; and a processor, the instructions configured to cause the processor to: capture small specimens of livescan fingerprint ridges using a scaled down fingerprint sensor, use RSM matching to find the ridge structure in a matching reference, use Level 3 Features to confirm the livescan-to-reference match, and use Level 3 features selectively based on “guidance” provided using Level 2 features.

### RELATED APPLICATION INFORMATION

The application claims priority under 37 U.S.C. 119(e) to U.S. Provisional Patent Application Ser. No. 62/096,767, filed on Dec. 24, 2014, which is incorporated herein by reference in its entirety.

### BACKGROUND

### 1. Field

The embodiments described herein are directed generally to the field of identifying persons using biometric recognition, and more particularly to the use of fingerprints captured through activities of everyday life such as using a keyboard while operating a computer or a keypad at a point of sale location.

### 2. Background

Given the number of networks and critical infrastructure either connected to the Internet or part of a large air-gapped intranet, Cyber-crime and Cyber-terrorism are clear and present threats. One of the neglected aspects of current initiatives to thwart Cyber-threats from the criminal or terrorist is to either immediately or after-the-fact be able to identify criminal or terrorist.

### SUMMARY

According to one aspect, a mobile device comprising memory configured to store instructions; and a processor, the instructions configured to cause the processor to: capture small specimens of livescan fingerprint ridges using a scaled down fingerprint sensor, use RSM matching to find the ridge structure in a matching reference, use Level 3 Features to confirm the livescan-to-reference match, and use Level 3 features selectively based on “guidance” provided using Level 2 features.

### BRIEF DESCRIPTION OF THE FIGURES

Features, aspects, and embodiments are described in conjunction with the attached drawings, in which:

FIG. 1 is a diagram illustrating a UIDM embedded in a smartphone in accordance with one embodiment;

FIG. 2 is a diagram illustrating a UIDM embedded in an ATM in accordance with one embodiment;

FIG. 3 is a diagram illustrating a half-inch segment of a single ridge of a fingerprint and its corresponding template in accordance with one example embodiment;

FIG. 4 is a block diagram illustrating the schematic layout of major components captured using ultrasonic scanner in accordance with one example embodiment;

FIG. 5 is a diagram illustrating the end-to-end process for converting a photo of a fingerprint to a viable fingerprint that can support searching and matching in accordance with one embodiment;

FIG. 6 is a block diagram illustrating an overview of the “ridge-centric” matching process when applied to latent fingerprint matching in accordance with one embodiment;

FIG. 7 is a diagram illustrating two corresponding ridges from different impressions from the same finger;

FIG. 8 is a diagram illustrating the hamming distance between the templates of these ridges;

FIG. 9 is a diagram illustrating a high-quality impression being matched against a 1000 dpi livescan, the discriminative power of level-3 ridge template matching can exceed the confidence of iris recognition;

FIG. 10 is a diagram illustrating an enlargement of image 2 revealing considerable ridge detail;

FIG. 11 is a diagram illustrating numerous use cases for the UIDM;

FIG. 12 is a diagram illustrating the use of ear structure that can be used to determine identity in a manner similar to fingerprint ridges; and

FIG. 13 is a diagram illustrating an example system in accordance with one embodiment.

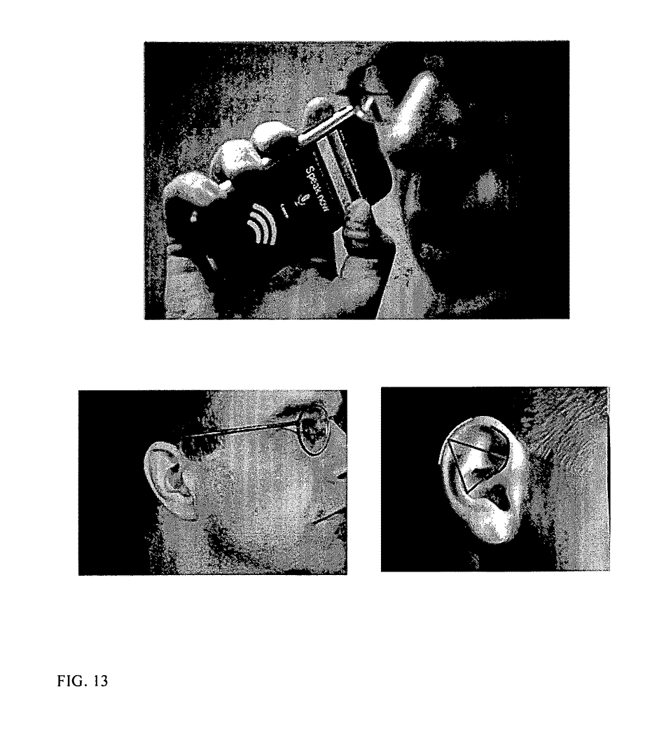

### DETAILED DESCRIPTION

The embodiments described herein will be described in terms of one or more examples, with reference to the accompanying drawings. Those skilled in the art will appreciate various novel approaches and features described herein and that these approaches and features, as they may appear herein, may be used individually, or in combination with each other as desired.

The embodiments described herein refer to an “Unobtrusive Identity Matcher” (“UIDM”) that resides on servers and receives input from sensors that provide images of fingers from keyboards, keypads, kiosks, ATMs, door locks, and the like. Three functions that can be included in the UIDM: (1) captures fingerprint images in a “passive” manner, (2) saves fingerprint images and (3) matches or verifies the fingerprint against enrolled records for a single individual or group of individuals either in real-time, near-real time or later retrieval. A purpose of the UIDM is to capture fingerprints and provide either immediate verification of identity or allow for later retrieve of the fingerprint of someone that used the above mentioned devices such as keyboards, keypads, kiosks, ATMS, door locks, and the like by requiring only minimal overt actions by the user. The UIDM can be embedded in devices and persistently operates in the “background” and when a user comes in contact with the sensor, it captures fingerprint information without requiring the user to take any special actions. Fingerprint image capture can be performed either with the fingerprint owner's knowledge or clandestinely within an environment that allows for clandestine fingerprint capture.

In particular, the embodiment(s) described, and references in the specification to “one embodiment”, “an embodiment”, “an example embodiment”, etc., indicate that the embodiment(s) described may include a particular feature, structure, or characteristic, but very embodiment may not necessarily include the particular feature, structure, or characteristic. Moreover, such phrases are not necessarily referring to the same embodiment. further, when a particular feature, structure, or characteristic is described in connection with an embodiment, persons skilled in the art may implement such feature, structure, or characteristic in connection with other embodiments whether or not explicitly described.

Embodiments may be implemented in hardware, firmware, software, or any combination thereof. Embodiments of the invention may also be implemented as instructions stored on a machine-readable medium, which may be read and executed by one or more processors.

A machine-readable medium may include any mechanism for storing or transmitting information in a form readable by a machine (e.g. a computing device). For example, a machine-readable medium may include read only memory (ROM); random access memory (RAM); hardware memory in handheld computers, PDAs, smart phones, and other portable devices; magnetic disk storage media; optical storage media; thumb drives and other flash memory devices; electrical, optical, acoustical, or other forms of propagated signals (e.g. carrier waves, infrared signals, digital signals, analog signals, etc.), Internet cloud storage, and others. Further, firmware, software, routines, instructions, may be described herein as performing certain actions.

However, it should be appreciated that such descriptions are merely for convenience and that such actions in fact result from computing devices, processors, controllers or other devices executing the firmware, software, routines, instructions, etc.

In one of many implementations, the UIDM provides a means to establish this collection for immediate or later identification by positioning itself at the “portals” to the Internet-such as keyboards in Cyber-cafes-monitoring the identity of persons behind internet activities. The “eyes” of the UIDM are cameras-either expressly embedded or those provided with the hardware such as webcams.

Attribution of cyber/network-related activities remains a critical issue at a number of levels: (1) At a macro level: identifying and authenticating the owners of domainsand IP addresses; (2) At an Internet/IP transaction level: no DNSSEC protocol utilization to allow track-back; and (3) At a “Last Mile” level: linking an individual to a device and a transaction performed on that device.

The UIDM focuses on all three variations cited above with an emphasis on the “Last Mile” problem. The UIDM solution offers user identification with the following attributes:
Easy: no incremental activities; no delay to use.
Cost-effective: cost at a small fraction of the overall device.
Unavoidable: persistent; done with or without the users' cooperation.
Unobtrusive: hidden from view in the usual form factors.

The UIDM Essentially, the UIDM is “next-generation” fingerprint (and other biometric) technology combined with very small embedded sensors such as cameras. The fingerprint matching technology adds ridge flow beyond the current “minutiae” approach thereby offering the capability of recognizing very low resolution or degraded fingerprints or small image fragments. This technology also widens the aperture to recognize more than just “traditional” fingerprints and can also recognize, finger tips, lower finger extensions, full palm, writer's palm and backs of fingers. This matching technology is bundled with small, standard, inexpensive cameras taking pictures for biometric matching. These cameras can fit into the numerous form factors including but not limited to:
Keyboards: under space bars, keys or in blank spaces.
Other input devices such as mouse and trackball.
Credit card and ATM readers.
In a server box or wall socket.
Remote controls.
Game controllers.
Cloud account authentication at retail stores or other locations

Fingerprints are truly the “human barcode” and among the best measures of human identity available. Fingerprints are similar to DNA as biometric identifiers because they can be obtained either directly from individuals or from things people have touched or places they have been. An additional advantage of fingerprints is they are readily captured through well proven techniques such as contact scanning or photography and can be rendered into identity immediately. For purposes of the UIDM, fingerprints offer identity at two levels: (1) the first level of associating identity takes the form of the ridges and minutiae that comprise the structure of the fingerprint; (2) the second level of identity can be found in the internal structure of the ridges in terms of pores and contour structure (These latter characteristics are typically referenced as “Level 3 Features”.).

The actual fingerprint features used by the UIDM depend on the resolution of the scanner. But, the quality of images from embedded cameras as well as the images produced by ultrasonic scanners both offer sufficient detail to show the ridge structure (Level 2) as well as the ridge contours and pores (Level 3). Additionally, with the finely detailed Level 3 features, much less surface area of the finger is necessary to conduct a search against reference prints than with Level 2 features along.

The UIDM offers a viable alternative to many other forms of identification control including passwords and “traditional biometrics” such as the practice of incorporating a fingerprint scanner within a device that requires an overt action by the user of the device. The UIDM provides a reliable and robust way to establish the identity of users on a real-time basis. Key to implementation of the UIDM is bundling identification capability with existing devices such as keypads and kiosks where people interact with devices and where the confirmation of identity is necessary.

In an example embodiment, using a “ridge-centric” matching method herein described, livescan fingerprints can be matched against their corresponding references using ridge shape and locational information. A “byproduct” of this approach is the pairing of corresponding ridge segments between two matched fingerprints. This pairing provides the opportunity to use Level 3 Features as a means of “verifying” the match made primarily on ridge segments.

This technique is particularly useful for matching fingerprints where the Level 3 Features are very sparse and may exist in a small part of the print—if they are available at all. By “surgically” matching ridge sections between a reference print with its corresponding ridges in a livescan print, a pairing of ridges can be established that can immediately be verified using Level 3 Features.

The example embodiment provides techniques for automatic verification and identification of livescan fingerprints based on Level-3 features (pores and indentations) of the fingerprint. Rather than using the 2d locations of individual pores, these techniques create and compare templates based on sequences of irregularities in the distribution of Level-3 features within each ridge.

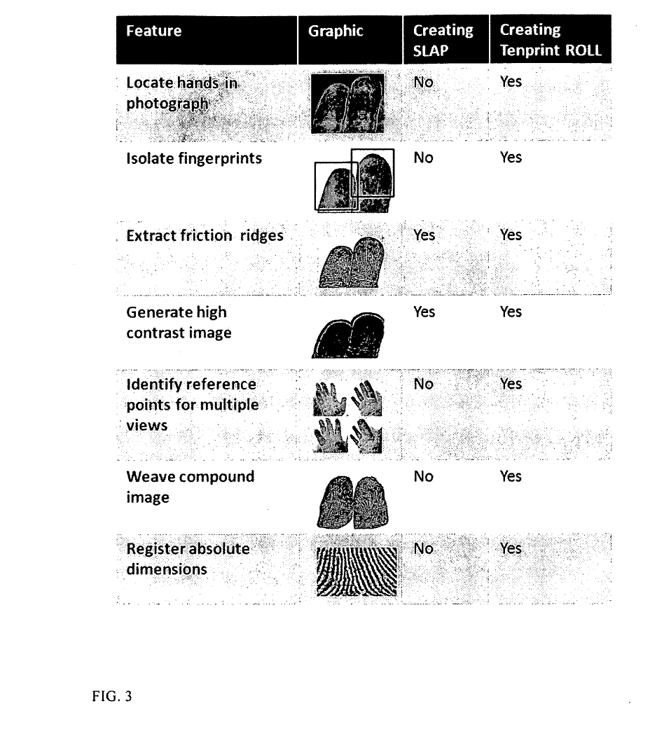

The features are represented as the thresholded Gabor wavelet response of bandpassed 1 d signals, which are extracted from the changes in intensity along the center line of each ridge. FIG. 3 shows a half-inch segment of a single ridge and its corresponding template. The inventor has found significant advantages in this kind of representation.

For example, using the approach in this example embodiment, the problem of matching one fingerprint to another is reframed from the difficult problem of approximate 2d correspondence under nonlinear distortion, to the relatively straightforward problem of approximate sequence alignment. Further, the matching process functions as a statistical test of independence: What is the probability that the two fingerprints could have been produced by two different fingers? A very low probability of independence represents significant and scientifically valid evidence, without appealing to the training or experience of any particular fingerprint examiner.

The problem of matching of small livescan fingerprints has not been effectively addressed by methods proposed in the prior art. Small fingerprints often lack minutiae necessary to support large-scale one-to-many matches. It has been demonstrated by published patent applications assigned to the RSM method provides a surrogate for minutiae when “traditional” minutiae are missing or sparse. Since ridge-centric matching aligns corresponding ridges between livescan and reference prints, Level 3 Features offer a logical extension of the ridge-centric method. Even in very small livescan prints with very limited Level 3 Features, the appearance of these features provides a powerful measure of identity.

Although illustrative embodiments have been described herein in detail, it should be noted and understood that the descriptions and drawings have been provided for purposes of illustration only and that other variations both in form and detail can be added thereto without departing from the spirit and scope of the invention. The terms and expressions in this disclosure have been used as terms of description and not terms of limitation. Thus, the breadth and scope of the present invention should not be limited by any of the above-described exemplary embodiments, but should be defined only in accordance with the claims and their equivalents. The terms and expressions herein should not be interpreted to exclude any equivalents of features shown and described, or portions thereof.

The embodiments described herein offer the end-to-end capability through a Smartphone (1) to capture small specimens of livescan fingerprint ridges using a scaled down fingerprint sensor; (2) to use RSM matching to find the ridge structure in a matching reference; (3) to use Level 3 Features to confirm the livescan-to-reference match; and (4) a method to use Level 3 features selectively based on “guidance” provided using Level 2 features. This latter method enhances security since it is possible to create a fingerprint template that does not contain all the identity information existing in the finger. If this template is compromised, a replacement can be generated using new information extracted from the finger.

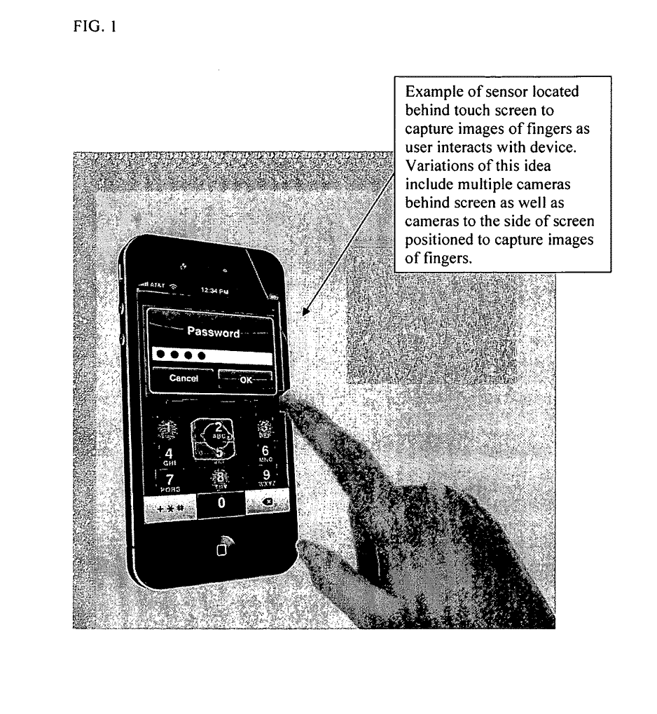

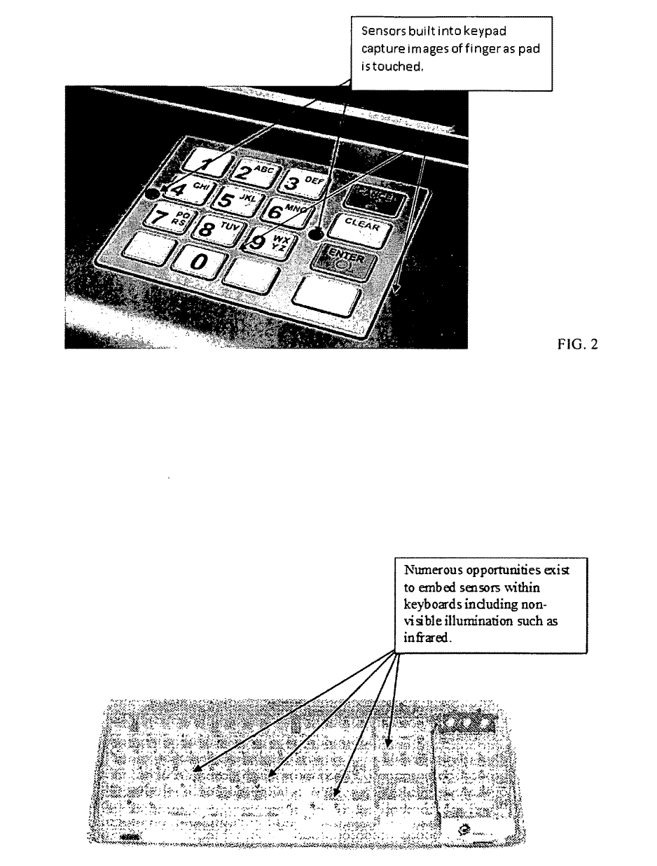

FIG. 1 illustrates the UIDM embedded in a smartphone. FIG. 2 shows it similarly embedded in an ATM key pad. For both these illustrations a camera is used as the sensor but the UIDM can also work with other sensors such as an ultrasonic fingerprint scanner.

In FIG. 2, the UIDM is unobtrusive and can be located underneath keyboard/keys, inside a mouse or hidden in other small confined devices. Either a single or multiple sensors, such as a cameras can be used with infrared lighting so as not to disturb/distract user and get good images. A video capture runs continuously and the images are polled in real time by an algorithm that checks for frame focus and evidence of finger ridges. As images are captured, they are sent to the fingerprint matcher and an identity is established. A remote server confirms it has a match or enough quality data to confirm no-match, calls for and signals the UIDM to stop transmitting. Ultrasonic scanners will also function in the examples shown in FIG. 2.

FIG. 3 shows an overview of a process of converting an image from an embedded camera into a fingerprint similar to that obtained through capacitance or optical scanners.

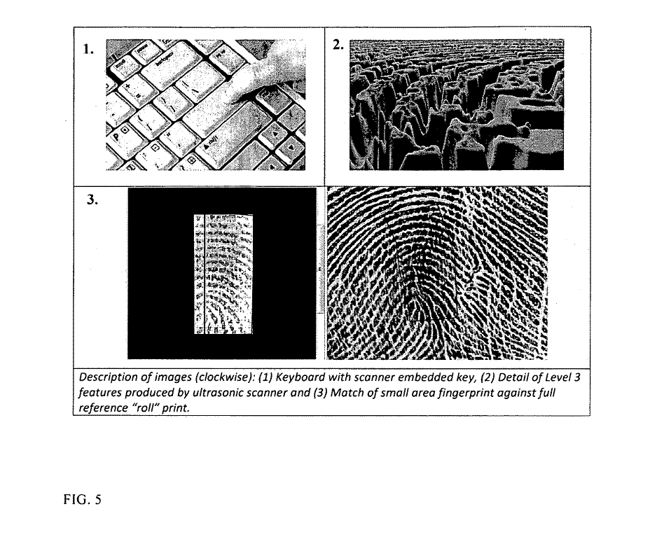

FIG. 5 shows the end-to-end process for converting a photo of a fingerprint to a viable fingerprint that can support searching and matching. The table within the figure outlines the steps for generating the fingerprint image. It should be noted the target output is a “flat” image of as many fingers as visible in the image since a flat fingerprint is the most common form used for searching. Once a sensor has captured the image, such as via a camera taking a photograph, the steps to develop it into a searchable fingerprint involve:

1. Locating fingers in the photograph.
2. Isolating fingerprint area.
3. Separating ridges and furrows through contrasting.
4. Generating a high contrast image separating ridges and furrows.
5. If multiple photographs are taken, find corresponding reference points that can be used to link the photographs together.
6. Weaving multiple images into a composite view.
7. Compression of images using WSQ or JPEG2K.
8. Location of minutiae on the high contrast image.
9. Generation of an AFIS query file. This file will be ANSI/NIST-ITL 1-2011 (AN2k11) and/or EBTS 9.4 compliant for compatibility with other biometric information systems.

### 10. Submission to an AFIS.

The UIDM's ability to capture fingerprints from finger images, employs techniques that take advantage of specular reflection of light from a finger surface, which varies depending on the local angle of the skin relative to the light source and camera. Contrast enhancement using adaptive histogram equalization allows for clear separation between ridges and valleys, and permits accurate fusion of multiple images taken from different angles. Once a dense map of correspondences is created between two or more images, two options are possible. The first is to combine the images to create a composition that enhances any area where one image may be weak. The result is the equivalent of a “flat” print. The second method is to create an accurate depth map to generate a 2D projection of the 3d finger surface: this is a rolled-equivalent fingerprint image. For most purposes, the flat fingerprint should be sufficient for identification since this is the most common form of print typically used for searching.

The flat-and-rolled-equivalent images produced by the UIDM are intended to conform to the NIST draft standard for Fast Ten-Print Capture (FTC) devices, with specific requirements for gray-level contrast and geometric accuracy. These standards mirror earlier requirements used to ensure that live-scan equipment would be widely accepted as a substitute for scanned fingerprint cards. If the images are composited into the equivalent of fingerprint “rolls”, this process can be performed subsequent to the actual imaging since the UIDM will capture so many images during a routine interaction between a user and a device containing the UIDM.

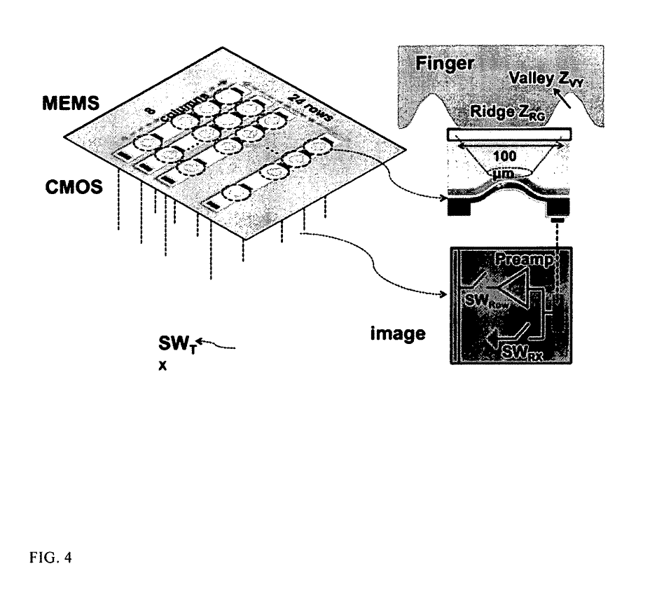

In addition to cameras, ultrasonic scanners can also be used to capture finger detail for the UIDM. FIG. 4 shows the schematic layout of major components in an ultrasonic scanner. An ultrasonic scanner uses ultrasonic transducers to transmit sound waves which are reflected by the skin and other tissue beneath the surface of the scan. Unlike cameras, optical and capacitive solutions, the ultrasonic sensor measures the dermal image behind the skin and is therefore not susceptible to superficial dirt and scars.

In ultrasonic fingerprint scanners, the ultrasound wave is started and stopped to produce a pulse. At each material interface encountered by the pulse, a portion of the pulse reflects. For example, the interface between the surface of the scanner and skin or the interface between air and skin may each reflect a portion of the pulse. The fraction of ultrasound reflected is a function of differences in impedance between the two materials comprising the interface.

The reflected wave pulses may be detected by a detector. The elapsed time during which the pulse traveled from the ultrasound pulse emitter to the interface and back may be determined. The elapsed time may be used to determine the distances traveled by the pulse and its reflected wave pulses. By knowing the distance traveled, the position of an interface may be determined.

There may be many interfaces encountered by the emitted pulse, and so there may be many reflected wave pulses. Since it is the interfaces associated with a finger that are of interest in generating an image of a fingerprint, it may be necessary to identify those reflected wave pulses that are associated with the finger. The approximate position of a finger being scanned may be known, and therefore the pulse reflected from the finger may be expected during a particular time interval. In a technique commonly referred to as “range gating”, a detector may be configured to ignore reflected pulses that are not received during that time interval. The reflected signals associated with the finger may be processed and converted to a digital value representing the signal strength. The digital value may be used to produce a graphical display of the signal strength, for example by converting the digital values to a gray-scale bitmap image, thereby producing a contour map of the finger surface which is representative of the depth of the ridge structure detail.

Key to the ultrasonic scanner is the fact that it can sense through various interfaces between materials. Such an interface could include the external casing of a device in which the scanner is embedded. FIG. 5 shows an overview of implementation of an ultrasonic scanner in a keyboard or similar device such as a mouse. In this implementation, the scanner becomes intrinsic to the device and not witting action is required by the user (other than use the device) to initiate the fingerprint capture process.

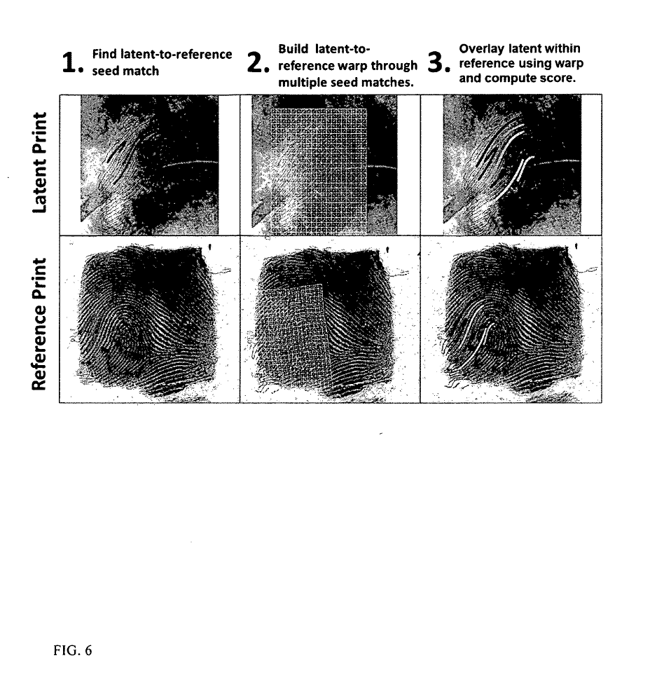

Once the fingers have been photographed and successfully rendered into an image, the UIDM is incorporates matching algorithms that can work with images obtained under less-than-ideal conditions. The UIDM incorporates three matching methods. The first method uses conventional minutiae and can be applied if the image is sufficiently large and rich with minutiae detail. Minutiae matching is the conventional method most fingerprint matchers use and is not discussed in further detail herein. The second method detects ridge-flow in the fingerprints as the basis for identity. This method is called Ridge-Specific Marker matching which is a graph-based method for capturing curve detail and relationships to describe objects that can be articulated as line forms. In the case of fingerprints, latent prints can be mapped to corresponding reference prints by matching the corresponding curvatures and locations within the friction ridges for multiple groupings. FIG. 6 shows an overview of the “ridge-centric” matching process when applied to latent fingerprint matching. The top row in this figure illustrates the latent print and the bottom row shows the corresponding relationship within the reference print. The first column illustrates the construction of “seeds” in the form of Bezier curves that match in latent and reference space. The second column illustrates the creation of the “warp” which captures the transformation of ridge structure from latent space to reference space due to the elasticity of skin. The third column shows the result, which is a direct mapping of the latent into reference space.

Although the second match algorithm incorporated in the UIDM can resolve identity by ridge flow patterns alone, its performance can be further enhanced by using the UIDM's third matching method that uses Level 3 Features visible in the fingerprints. Level 3 Features encompass pores and the contour shape of the ridges. By “surgically” matching ridge sections between a two fingerprints, a pairing of ridges can be established that can immediately be verified using Level 3 Features.

Many fingerprint examiners believe that identity can be established with as little as a single fingerprint ridge. Since the ridge would contain no “traditional” minutiae that are the mainstay of most fingerprint matchers and since there would be no ridge flow available to assist in matching, the remaining way to extract identity from a single ridge would be through Level 3 Features. These features include the pores within the ridges as well as the indentations along the contour of the ridge.

However, attempts to use these features for identification in the prior art have met with obstacles. With the exception of full fingerprints collected using high quality live scanners, the Level 3 Features are typically not captured with sufficient detail to permit useful analysis. In the case of latent fingerprints, the features are often non-existent within images of the latent fingerprint. However, when the images are of high quality, even a small area of the print will reveal very power Level 3 Feature data. The final obstacle in the prior art was the absence of a reliable automated approach to analyzing Level 3 Features to perform matching—hence, the present invention is offers an automated solution to the Level 3 Feature matching problem.

The features are represented as the thresholded Gabor wavelet response of bandpassed 1D signals, which are extracted from the changes in intensity along the center line of each ridge.

FIG. 5 shows a half-inch segment of a single ridge and its corresponding template. The advantages of this kind of representation are significant: The problem of matching one fingerprint to another is reframed from the difficult problem of approximate 2d correspondence under nonlinear distortion, to the relatively straightforward problem of approximate sequence alignment.

The matching process functions as a statistical test of independence: What is the probability that the two fingerprints could have been produced by two different fingers? A very low probability of independence represents significant and scientifically valid evidence, without appealing to the training or experience of any particular latent examiner. The template of a noisy or low-quality print will be uncorrelated with other low-quality prints, and will not yield a spurious match.

A single ridge or ridge fragment can contain enough information to identify a latent fingerprint (˜400 effective degrees of freedom per linear inch).

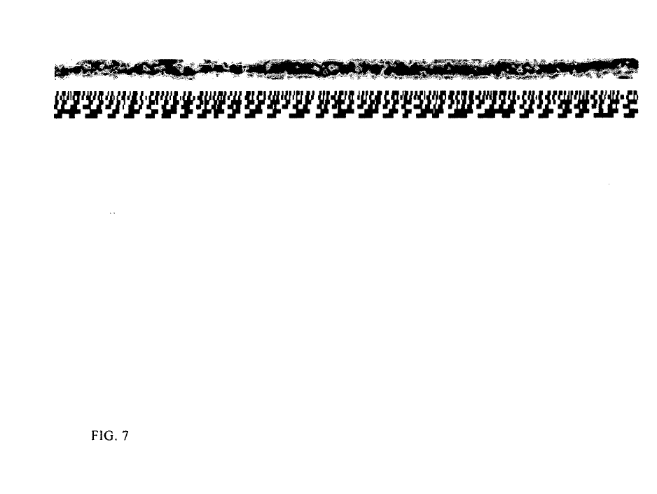

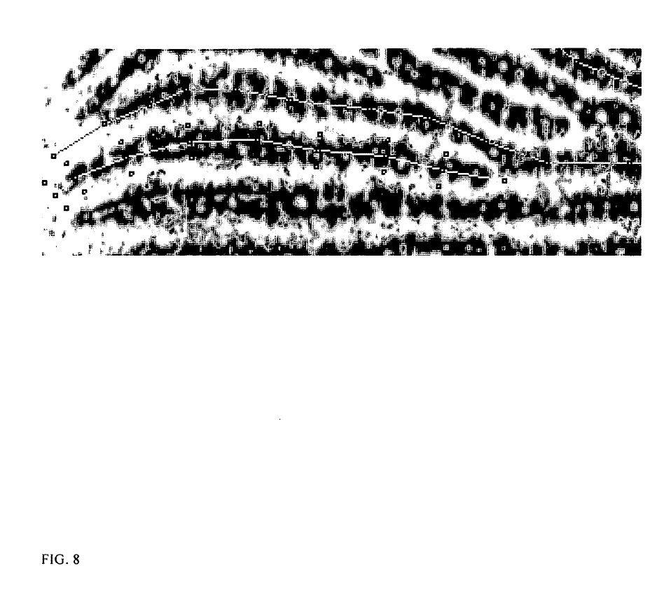

FIG. 7 shows two corresponding ridges from different impressions from the same finger. These corresponding ridges are shown as a dotted line. The hamming distance between the templates of these ridges is shown in FIG. 8 in the form of the vertical line (left side of image), well outside of the distribution of impostor hamming distances, shown in the large “bell curve”. The probability of the highlighted segments having this degree of correspondence by chance is less than one in 10 million. The segments are approximately ¼ inch in length.

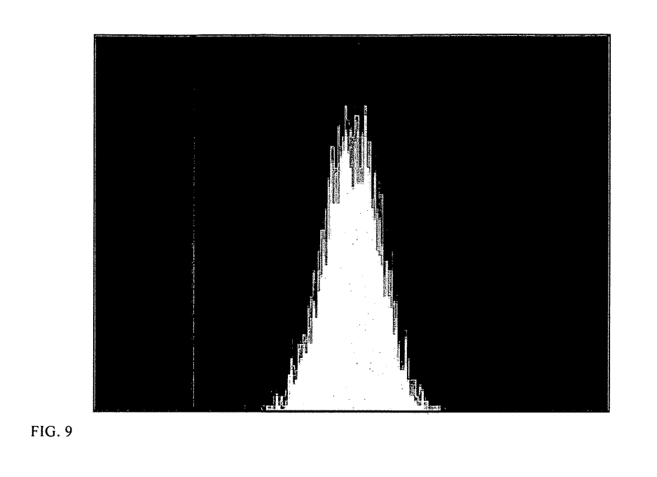

FIG. 9 shows a high-quality impression being matched against a 1000 dpi livescan, the discriminative power of level-3 ridge template matching can exceed the confidence of iris recognition. The (approximately binomial) distribution of bits in a high-quality fingerprint template exceeds 10,000 effective degrees of freedom, versus ˜250 for an “Iris Code”.

Level 3 matching can be used in conjunction with either minutiae or ridge-based matching techniques. For one-to-one comparisons, tests can be performed on pre-aligned ridge segments in order to reduce the number of comparisons needed relative to a naive comparison. For identification purposes, high-performance sequence alignment algorithms such as BLAST and FASTA, widely used in the field of bioinformatics to match nucleotide sequences, can be applied to dramatically speed up an exhaustive database search.

The image sources for the UIDM are typically originated via small embedded sensors such as cameras adapted for macro photography since the fingers will pass within inches of the camera. Focus, lighting and motion are critical issues effecting the quality of photographs from embedded cameras.

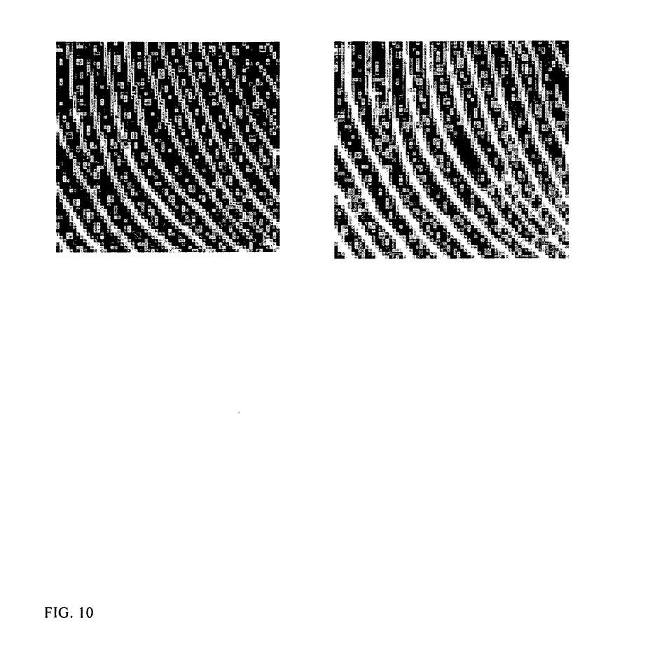

Fingerprints are captured by monitoring the video stream from the embedded device such as a camera looking for images that are in sufficiently in focus to expose the ridge flow. There are numerous algorithms for automatic focus control. The common denominator among most of them is finding contrast detection. Contrast detection autofocus is achieved by measuring contrast within a sensor field, through the lens. The intensity difference between adjacent pixels of the sensor naturally increases with correct image focus. Since in the case of the UIDM the camera focus is fixed, the stream of video images is continuously processed and as maximum contrast is detected that image is selected for further review and analysis. FIG. 9 shows a series of images capturing continuous motion of a finger in front of an embedded camera. In this figure, image 2 is the one that is in focus. The insert in FIG. 10 shows an enlargement of image 2 revealing considerable ridge detail.

The UIDM operates by constantly checking frames for focus. The embedded camera is positioned so that the only objects coming within the range of focus will be fingers. When fingers are in focus, their ridge detail is clearly visible and the focused frames can be isolated. Within the focused frames, further filtering can be achieved using a Hough transform or Adaptive Classification that can detect the unique signature of parallel ridges. In the case of Adaptive Classification, the classifier uses a map of primary orientation within areas of the image with high variance in one direction and low variance in the other, taking into account the narrow range of frequencies that include fingerprint ridges. As images containing fingerprint ridges are detected, they are transmitted away from the embedded sensor to a remote server for review and analysis.

When the image source for the UIDM is a scanner—ultrasonic or otherwise—the images produced from the scanner are treated as individual items. The scanner typically has intrinsic sensing capability to “know” when to capture an image and at the conclusion of image capture, the scanner exports this image.

Because of the constant interaction between user and device with embedded UIDM, there are numerous opportunities to capture scanned images enhancing the chances that more than one will be of quality suitable for matching against reference fingerprint to obtain identity.

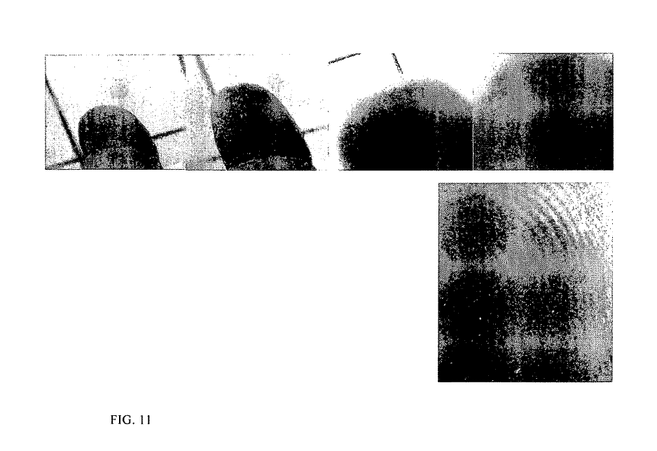

FIG. 11 shows numerous use cases for the UIDM that include but are not limited to (clockwise from upper left corner) (1) scanning prints and hands from smartphones during presentation for aircraft boarding or point of sale; (2) scanning prints to corroborate identity while using ATMs or other kiosk-based devices; and (3) capturing fingerprint images from a keyboard, mouse, track-pad or other input device.

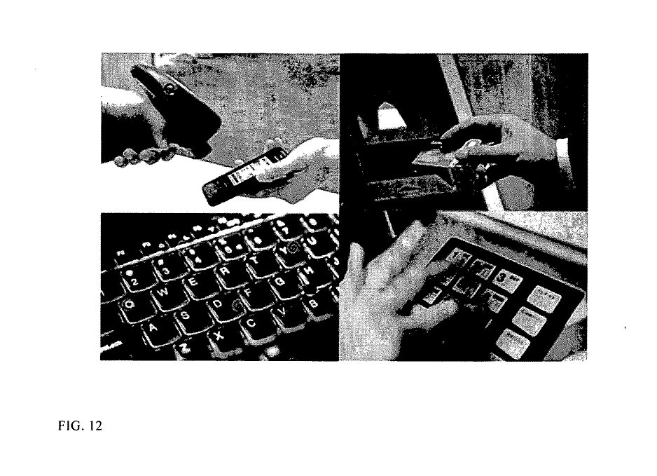

The UIDM is not restricted to fingerprints as the only biometric modality that can be used for matching. FIG. 12, shows the use of ear structure that can be used to determine identity in a manner similar to fingerprint ridges.

Furthermore, the UIDM is not restricted to photography as the principal means of capturing fingerprint information. Ultrasonic scanning technology provides a means of obtaining fingerprints that can actually “see through” the surface coverings on objects.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A mobile device comprising:
memory configured to store instructions; and
a processor, the instructions configured to cause the processor to:
capture small specimens of livescan fingerprint ridges using a scaled down fingerprint sensor,
use RSM matching to find the ridge structure in a matching reference,
use Level 3 Features to confirm the livescan-to-reference match, and
use Level 3 features selectively based on “guidance” provided using Level 2 features.
